(19) United States
(12) Patent Application Publication
(10) Pub. No.: US 2024/0386259 A1
(43) Pub. Date: Nov. 21, 2024

(54) IN-PLACE TENSOR FORMAT CHANGE

(71) Applicant: Microsoft Technology Licensing, LLC, Redmond, WA (US)

(72) Inventors: Asaf LEVY, Hod Hasharon (IL); Evgeny ROYZEN, Qiryat Ono (IL); Yaron Baruch SHAPIRO, Petach Tikva (IL); Khalil Abdul-Hamid WATTAD, Jatt (IL)

(21) Appl. No.: 18/318,521

(22) Filed: May 16, 2023

(51) Int. Cl. G06N 3/063; G06N 3/0464

(52) U.S. Cl. CPC G06N 3/063; G06N 3/0464

(57) ABSTRACT

A neural processing unit (“NPU”) is enabled to process tensor format and dimensional changes within the NPU during import and export of tensor data to and from the NPU, and between execution of successive computation steps (e.g., between successive convolution operations being executed in sequence). The NPU features an input data handler, an N×M systolic array and an output data handler. Such in-place tensor format changes are enabled by equipping an input data handler with format change hardware, and operating the NPU such that the input data handler and output data handler and related hardware tracks the format state of tensors moving into and out of an N×M systolic array and may therefore alter the format of such tensors on the fly.

### BACKGROUND

A neural processing unit (NPU) is a specialized processing unit (e.g., a microprocessor) configured to accelerate performance of machine learning (ML) tasks for applications including neural networks. An NPU may be implemented to free up a central processing unit (CPU) and/or graphical processing unit (GPU) to perform other (e.g., non-ML) computing tasks. For example, an NPU may improve the performance of a convolutional neural network (CNN) that processes images. In use, an NPU may receive input data in the form of tensors (multi-dimensional arrays of data), perform operations including convolutions on the input tensors, and generate a result.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are provided for greater efficiency in the training of, and subsequent generation of inferences by, deep neural networks. In an example aspect, a neural processing unit (“NPU”) is provided that includes a data arbiter, input data handler, data router, a systolic array of compute clusters and an output data handler. In a further aspect, the data arbiter receives tensor data in a first data format and tensor metadata comprising a tensor data descriptor corresponding to the first data format. In a further aspect, the data arbiter sends the tensor data and a command corresponding to the tensor data descriptor to the input data handler. In response to the command, the input data handler generates first metadata corresponding to the first data format, and sends the tensor data and the first metadata to the data router that in turn routes the tensor data according to the first metadata into the compute clusters of the clusters of the systolic array.

In a further example aspect, the compute clusters each include cluster processing logic and cluster memories, and wherein the cluster processing logic of each compute cluster performs an operation on the tensor data stored in the respective cluster memory to generate a cluster result for each cluster, and wherein the cluster results for all clusters collectively comprise output data.

In another example aspect, the output data handler is coupled between the systolic array and the input data handler and configured to receive the output data from the systolic array, format the output data in a second data format, and to send the output data back to the input data handler. The input data handler generates second metadata corresponding to the second data format and sends the output data and the second metadata to the data router that in turn routes the output data to compute clusters of the systolic array for further computations.

In another example aspect, the input data handler may alternatively format the output data in a third format, and send the formatted output data to the data arbiter that in turn exports the formatted output data off the NPU.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts an example artificial neuron suitable for use in a deep neural network (“DNN”), according to an embodiment.

FIG. 2 depicts an example DNN composed of artificial neurons, according to an embodiment.

FIG. 3 depicts a block diagram view of a portion of a 50-layer convolutional neural network (“CNN”), according to an embodiment.

FIG. 4a depicts an example tensor package that may comprise the input data set to a DNN, according to an embodiment.

FIG. 4b depicts an in-memory storage representation of the example tensor package of FIG. 4a in a first memory storage format, according to an embodiment.

FIGS. 5a and 5b depict in-memory storage representations of the example tensor package of FIG. 4a in first and second memory storage formats, respectively, according to an embodiment.

FIG. 6 depicts a detailed block diagram view of a neural processing unit (“NPU”), according to an embodiment.

FIG. 7 depicts a detailed block diagram view of an input data handler, according to an embodiment.

FIG. 8 depicts a detailed block diagram view of a systolic array cluster, according to an embodiment.

FIG. 9 depicts a diagram illustrating an example distribution of an NHWC formatted vector into the systolic array of FIG. 6, according to an embodiment.

FIG. 10 depicts a flowchart of an example method for operating a neural processing unit (“NPU”), according to an embodiment.

FIGS. 11a through 11e depict flowcharts of refinements to the flowchart of FIG. 10, according to example embodiments.

FIG. 12 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A deep neural network (DNN) is a type of artificial neural network (ANN) with multiple layers between the input and output layers, and that conceptually is comprised of artificial neurons. Recently, the trend has been towards DNNs with ever increasing size, and current DNNs may be characterized by millions of parameters each represented in any data format (e.g., int8, uint8, float32, etc.). Training and various inference tasks given to such DNNs can be challenging since it may be difficult or impossible to achieve scalable solutions. For example, a central processing unit (“CPU”) is typically comprised of general purpose hardware components for handling arithmetic, logic and I/O operations integrated on a single chip. CPUs may be used for DNNs but suffer from poor performance because CPUs are adapted for sequential operations rather than parallel operations. Training a DNN, on the other hand, requires performing many operations in parallel.

The shortcomings of CPUs may, in part, be addressed by employing graphics processing units (“GPUs”). A GPU is a type of processor that typically has a large number of computational cores and originally was employed to calculate and render graphics. Such calculations and rendering of graphics require many operations to be performed in parallel by dividing the tasks into subtasks and distributing the workload across the many compute cores of the GPU. Thus, GPUs by nature enable the types of performant parallel processing required by DNN training.

Despite the improved performance of a GPU vs. a CPU, the ever increasing size of DNNs creates performance, energy and cost challenges for even GPU-based DNN solutions. These challenges have led to the development of custom hardware solutions specifically tailored to the acceleration of machine learning algorithms. Such hardware is typically referred to as a neural processing unit (“NPU”) or tensor processing unit (“TPU”).

Typical machine learning algorithms operate on large amounts of data iteratively. For example, a type of DNN called a convolutional neural network (“CNN”) is particularly useful for machine vision and image classification applications. A CNN typically performs a number of convolution operations using image data provided to the model. Such data typically comprises batches of 3-dimensional tensor data stored in a predetermined format. The operations performed by a CNN are provided such tensor data as input, perform operations on that data to create an intermediate result, and further operations are thereafter performed on such intermediate results. Such machine learning operations may require format conversion of tensor data arriving at the NPU, of the intermediate results during training of the CNN and/or of the final output of the CNN. Such format conversions historically have been performed outside the NPU which then requires data to be moved on and off the NPU for each operation which inhibits performance and scalability of DNNs implemented on such an NPU.

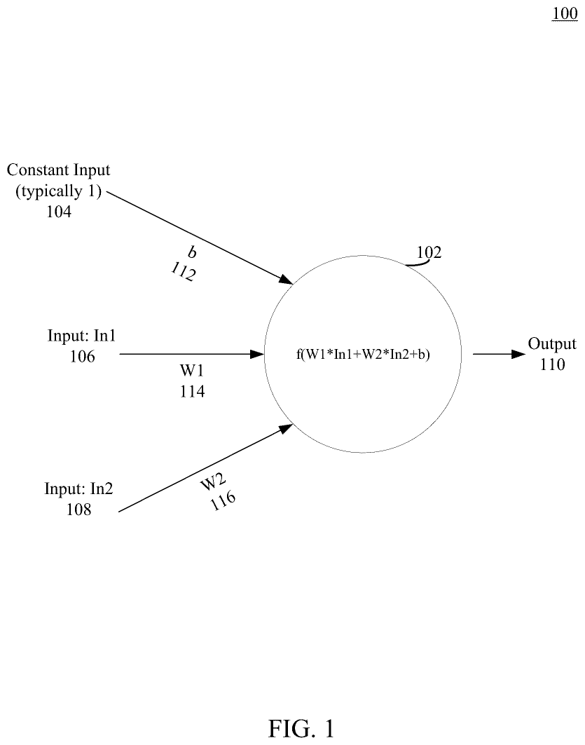

DNNs, including CNNs, may be constructed to perform various image, voice or text recognition tasks. For example, FIG. 1 depicts an example artificial neuron 100 suitable for use in a DNN, according to an embodiment. Neuron 100 includes an activation function 102, a constant input CI 104, an input In1 106, an input In2 108 and output 110. Neuron 100 of FIG. 1 is merely exemplary, and other structural or operational embodiments will be apparent to persons skilled in the relevant art(s) based on the description neuron 100 of FIG. 1, which follows.

Neuron 100 operates by performing activation function 102 on weighted versions of inputs CI 104, In1 106 and In2 108 to produce output 110. Inputs to activation function 102 are weighted according to weights b 112, W1 114 and W2 116. Inputs In1 106 and In2 108 may comprise, for example, normalized or otherwise feature processed data (e.g., images). Activation function 102 is configured to accept a single number (i.e., in this example, the linear combination of weighted inputs) based on all inputs, and to perform a fixed operation. As known by persons skilled in the relevant art(s), such operation may comprise, for example, sigmoid, tanh or rectified linear unit operations. Input CI 104 comprises a constant value (commonly referred to as a ‘bias’), which may typically be set to the value 1, and allows the activation function 502 to include a configurable zero crossing point as known in the relevant art(s).

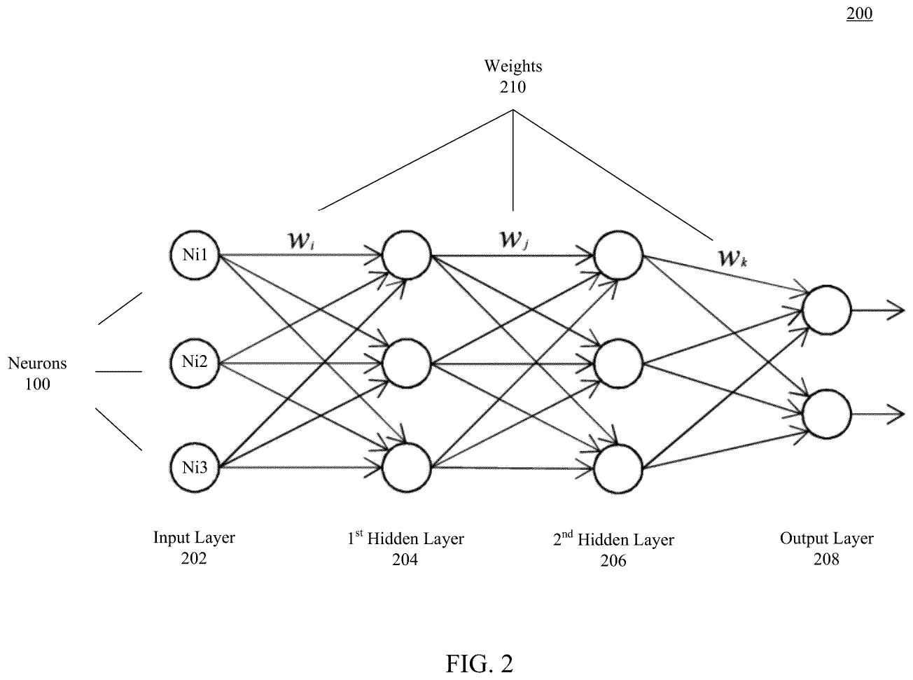

A single neuron generally will accomplish very little, and a useful machine learning model will require the combined computational effort of a large number of neurons working in concert (e.g., ResNet50 with ˜94,000 neurons). For instance, FIG. 2 depicts an example deep neural network (“DNN”) 200 composed of a plurality of neurons 100, according to an embodiment. DNN 200 includes neurons 100 assembled in layers and connected in a cascading fashion. Such layers include an input layer 200, a first hidden layer 204, a second hidden layer 206 and an output layer 208. DNN 200 depicts outputs of each layer of neurons being weighted according to weights 210, and thereafter serving as inputs solely to neurons in the next layer. It should be understood, however, that other strategies for interconnection of neurons 100 are possible in other embodiments, and as is known by persons skilled in the relevant art(s).

The neurons 100 of input layer 202 (labeled Ni1, Ni2 and Ni3) each may be configured to accept normalized or otherwise feature engineered or processed data corresponding to sensor data 106 as described above in relation to neuron 100 of FIG. 1. The output of each neuron 100 of input layer 202 is weighted according to the weight of weights 210 that corresponds to a particular output edge, and is thereafter applied as input at each neuron 100 of 1^{st} hidden layer 204. It should be noted that each edge depicted in DNN 200 corresponds to an independent weight, and labeling of such weights for each edge is omitted for the sake of clarity. In the same fashion, the output of each neuron 100 of first hidden layer 204 is weighted according to its corresponding edge weight, and provided as input to a neuron 100 in 2^{nd} hidden layer 206. Finally, the output of each neuron 100 of second hidden layer 206 is weighted and provided to the inputs of the neurons of output layer 208. The output or outputs of the neurons 100 of output layer 208 comprises the output of the model. In the context of the descriptions above, weight matrix 302 of compressed representation 212 is comprised of weights 210. Note, although output layer 208 includes two neurons 100, embodiments may instead include just a single output neuron 100, and therefore but a single discrete output. Note also, that DNN 200 of FIG. 2 depicts a simplified topology, and typically, producing useful inferences from a DNN like DNN 200 typically requires far more layers, and far more neurons per layer. Thus, DNN 200 should be regarded as a simplified example.

Construction of the above described DNN 200 is part of generating a useful machine learning model. The accuracy of the inferences generated by such a DNN require selection of a suitable activation function, and thereafter the each of the weights of the entire model are adjusted to provide accurate output. The process of adjusting such weights is called “training.” Training a DNN, or other type of neural network, requires a collection of training data of known characteristics. For example, where a DNN is intended to predict the probability that an input image of a piece of fruit is an apple or a pear, the training data would comprise many different images of fruit, and typically including not only apples and pears, but also plums, oranges and other types of fruit. Training requires that the image data corresponding to each image is pre-processed according to normalization and/or feature extraction techniques as known to persons skilled in the relevant art(s) to produce input features for the DNN, and such features are thereafter input to the network. In the example above, such features would be input to the neurons of input layer 202.

Thereafter, each neuron 100 of DNN 200 performs their respective activation function operation, the output of each neuron 100 is weighted and fed forward to the next layer and so forth until outputs are generated by output layer 208. The output(s) of the DNN may thereafter be compared to the known or expected value of the output. The output of the DNN may then be compared to the expected value and the difference fed backward through the network to revise the weights contained therein according to a backward propagation algorithm as known in the art. With the model including revised weights, the same image features may again be input to the model (e.g., neurons 100 of input layer 202 of DNN 200 described above), and new output generated. Training comprises iterating the model over the body of training data and updating the weights at each iteration. Once the model output achieves sufficient accuracy (or outputs have otherwise converged and weight changes are having little effect), the model is said to be trained. A trained model may thereafter be used to evaluate arbitrary input data, the nature of which is not known in advance, nor has the model previously considered (e.g., a new picture of a piece of fruit), and output the desired inference (e.g., the probability that the image is that of an apple).

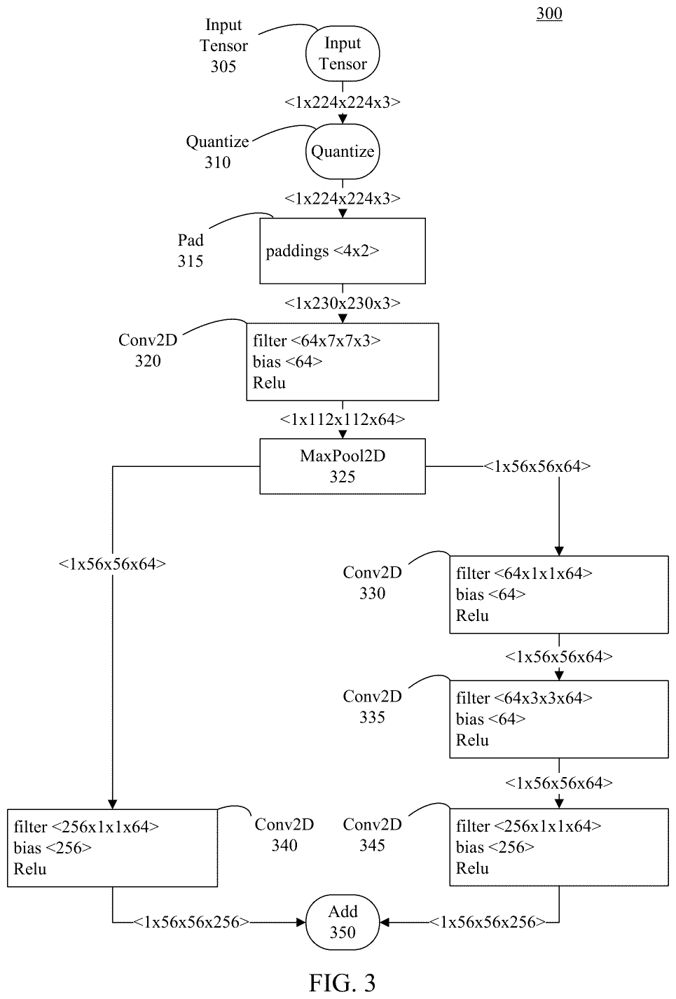

DNNs may be constructed in various ways. For example, FIG. 3 depicts a block diagram view of a portion of a 50-layer convolutional neural network (“CNN”) 300, according to an embodiment. More specifically, FIG. 3 depicts a portion of the network that comprises the so-called ResNet50 CNN. In FIG. 3, CNN 300 includes an input tensor 305, a quantize stage 310, a padding stage 315, 2-dimensional convolution stages 320, 330, 335, 340 and 345, 2-dimensional MaxPool stage 325 and add stage 350. Other structural and operational embodiments will be apparent to persons skilled in the relevant art(s) based on the following discussion regarding CNN 300 as depicted in FIG. 3.

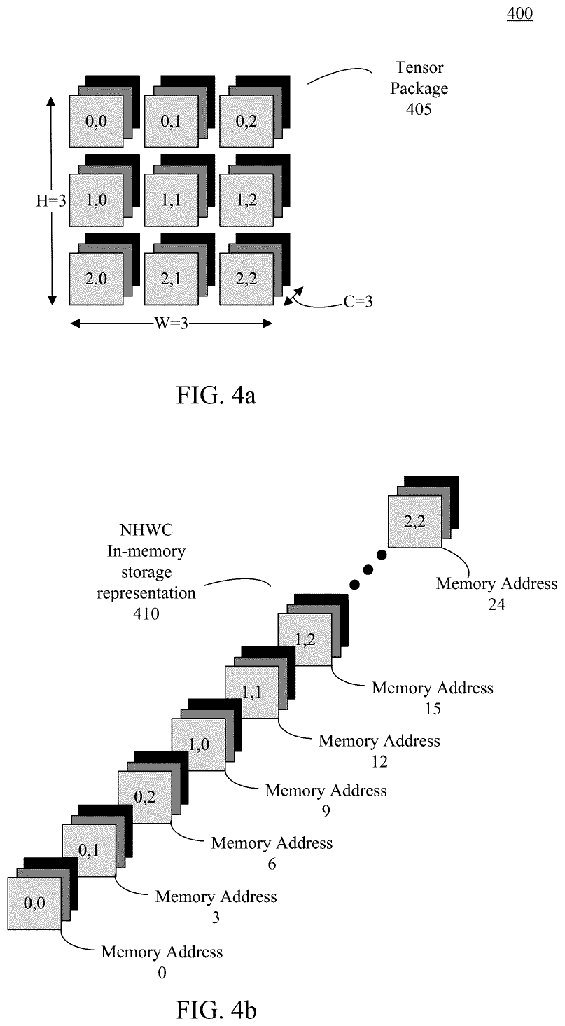

Pre-trained versions of the ResNet50 CNN as partially depicted in FIG. 3 are available that have been pretrained on millions of 224×224 pixel images, and that can classify images into 1000s of object categories, such as a keyboard, mouse, pencil, and many animals. Input tensor 305 of FIG. 3 comprises a 4-dimensional tensor package denoted as <1×224×224×3> in a <B. H. W. C> format wherein B is batch size, H is height, W is width and C is number of channels (or depth). More specifically, input tensor 305 includes 1 batch of data, has a height of 224, a width of 224 and 3 channels. As discussed above, a trained version of the ResNet50 CNN will classify (i.e., identify the content of) a 224×224 pixel image provided to the network. Input tensor 305 comprises such an image. A batch size of 1 denotes that the input tensor 305 includes a single image and H and W correspond to the 224×224 pixel dimensions of the image. Each of the 3 channels may represent the RGB color space values of the respective pixels. Input tensor 305 of FIG. 3 will now be discussed further in conjunction with FIGS. 4a and 4b.

In particular, FIG. 4a depicts an example <1×3×3×3> tensor package 405 that may comprise the input data set to a DNN, according to an embodiment. FIG. 4b depicts an in-memory storage representation 410 of the example 1×3×3×3 tensor package of FIG. 4a in a NHWC memory storage format, according to an embodiment. Other structural and operational embodiments will be apparent to persons skilled in the relevant art(s) based on the following discussion regarding tensor package 405 and in-memory storage representation 410 of FIGS. 4a and 4b, respectively.

With reference to FIG. 3, and as discussed above, input tensor 305 comprises a <1×224×224×3> tensor package. For the sake of ease of illustration, FIG. 4a depicts a <1×3×3×3> tensor package that may, for example, correspond to a 3×3 pixel image and RBG color space values for each pixel. Tensor package 405 is a single batch and thus is depicted as a 3-dimensional tensor. The 3-dimensional depiction of tensor package 405 is merely conceptual. That is, the CNN 300 partially depicted in FIG. 3 does not operate on a 3-dimensional object. Instead, computations are performed on data that is stored as conventional digital data in, for example, a storage device, SD RAM or static RAM. As such, the data values that comprise the 3-dimensional tensor package 405 as depicted in FIG. 4a are stored in memory in a contiguous portion of linear storage.

There are numerous ways of storage a 3-dimensional tensor in a linear memory space. For example, FIG. 4b depicts the in-memory storage representation 410 of the example 1×3×3×3 tensor package of FIG. 4a in a NHWC memory storage format, according to an embodiment. In addition to the NHWC memory storage format, 3-dimensional tensor packages are commonly stored in NCHW and NCWH formats. Each of these formats will now be discussed.

The abovementioned memory storage formats differ in the in-memory order of the data elements of the 3-dimensional tensor. In the NHWC memory storage format, the elements of the 3-dimensional tensor are ordered by starting at 0.0 which is the upper left most stack of elements of tensor package 405 and traversing the elements first along the C axis, then the W axis and finally the H axis. As illustrated in FIG. 4b, the top-most element at 0,0 maps to memory address 0 and the next two data elements are selected by traversing into the page along the C axis. After traversing fully along the C axis, one traverses next along the W axis and puts the top-most element at location 0,1 in memory address 3. After traversal of the first row completes, the process repeats over the following rows by traversing down the H axis and filling memory locations in the same manner.

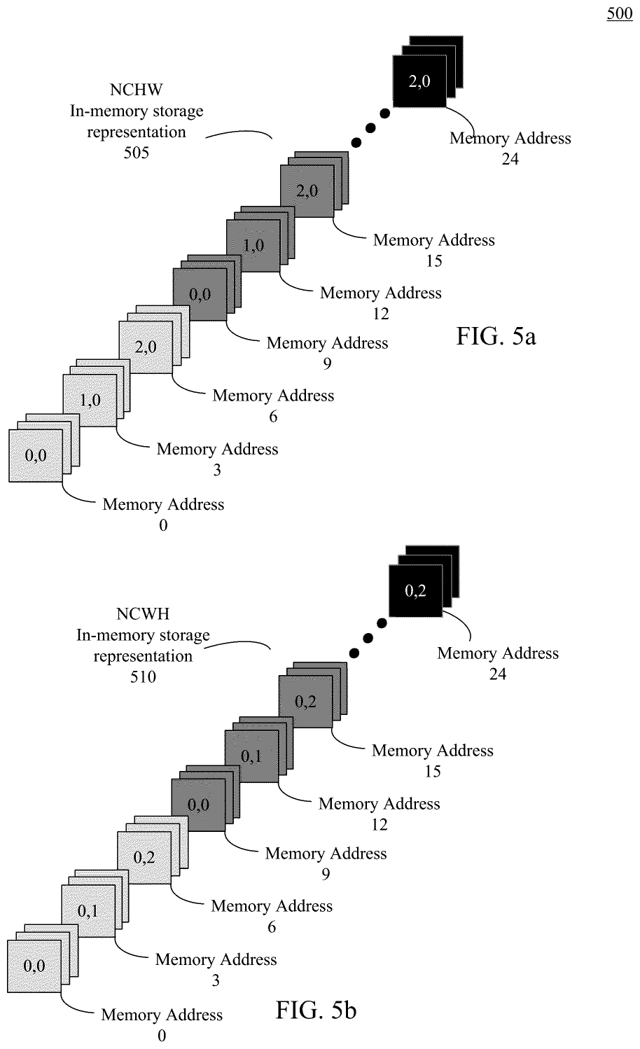

As mentioned above, two other common in-memory storage formats are NCHW and NCWH. FIGS. 5a and 5b depict in-memory storage representations 505 and 510, respectively, of the example 1×3×3×3 tensor package 405 of FIG. 4a in NCHW and NCWH memory storage formats, respectively, according to an embodiment. These memory storage formats require a different traversal order of tensor package 405 than that of NHWC discussed above. For the NCHW memory storage format, a tensor is traversed first along the W axis, then H and finally C. Likewise, the NCWH memory storage format traverses a tensor first along the H axis, then W axis and finally the Caxis. The result of such traversals is depicted by in-memory storage representations 505 and 510 of FIGS. 5a and 5b, respectively.

As described above, typical machine learning algorithms operate on large amounts of data iteratively. For example, the ResNet50 CNN as partially depicted in FIG. 3, and as discussed above, performs a number of convolution operations using image data provided to the model. For example, and with reference to FIG. 3, input tensor 305 is provided to the CNN which in turn performs the operations illustrated in FIG. 3. For example, input tensor 305 may comprise a 224×224 image provided to the CNN which then processes the image to classify (i.e., identify) the content of the image. Such processing includes, for example, performing the 2-dimensional convolution step 330 and passing the intermediate result (denoted as a <1×56×56×64> tensor package in FIG. 3) of that step to the next 2-dimensional convolution step 335. In typical NPUs, such an intermediate result may have to be exported from the NPU, the NPU reconfigured to perform the next convolution operation and the intermediate result then imported back into the NPU for application of the next convolution step.

In other situations, the in-memory format of the data may need to change from one step to the next. For example, it may be beneficial from a performance perspective for the output of convolution step 330 to be in an NCWH memory format whereas convolution step 335 may require the intermediate result tensor to be in NHWC format. Typical NPUs likewise may require the intermediate result to be exported from the NPU to undergo format conversion from the NCWH format to the NHWC format, and the converted tensor imported back to the NPU.

In still other situations, a particular machine learning algorithm may require a tensor to undergo a dimension change for further processing. For example, a 1×6 tensor may need to change to a 2×3 tensor for further processing. Typical NPUs likewise may require the tensor to be exported from the NPU, the dimensions changed, and the altered tensor to be re-imported to the NPU for further processing.

In each of the instances described above, exporting and re-importing tensor data to the NPU dramatically reduces the performance of the NPU due to the overhead of moving data on and off the NPU, and the poor performance of external memory needed to store the tensor for operations. Embodiments of neural processing unit 605 as described herein advantageously provide for in-place tensor format and dimension changes within neural processing unit 605, and without requiring tensor to move on and off the NPU. by processing the Such data typically comprises batches of 3-dimensional tensor data stored in a predetermined format. The operations performed by a CNN are provided such tensor data, perform operations on that data to create an intermediate result, and further operations are thereafter performed on such intermediate results. Such machine learning operations may require format conversion of tensor data arriving at the NPU, of the intermediate results during training of the CNN and/or of the final output of the CNN. Such format conversions historically have been performed outside the NPU which then requires data to be moved on and off the NPU for each operation which inhibits performance and scalability of DNNs implemented on such an NPU.

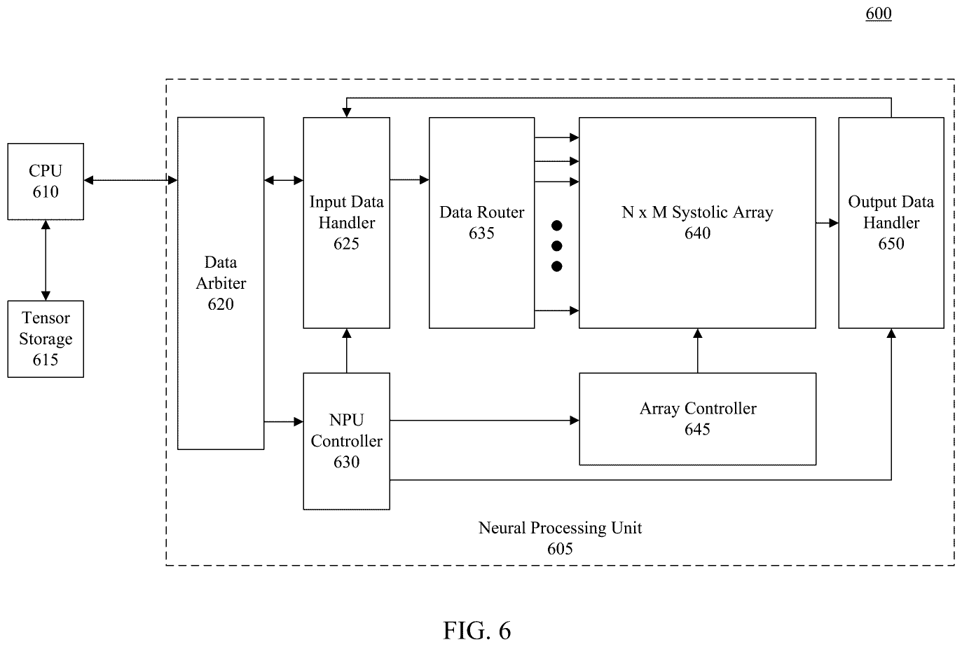

Embodiments featuring in-place data format changes in a CNN may be implemented in various ways. For instance, FIG. 6 depicts a detailed block diagram view of a system 600 that includes a CPU 610, a tensor storage 615, and a neural processing unit (“NPU”) 605, according to an embodiment. Neural processing unit 605 includes a data arbiter 620, an input data handler 625, an NPU controller 630, an N×M systolic array 640, an array controller 645, and an output data handler 650. Other structural and operational embodiments will be apparent to person skilled in the relevant art(s) based on the following discussion regarding system 600 as depicted in FIG. 6.

For the purposes of describing the operation of neural processing unit 605, assume that neural processing unit 605 implements a trained CNN such as, for example, ResNet50 as described above, and that neural processing unit 605 is thereby configured to perform image classification. It should be understood, however, that other types of DNNs may usefully be implemented in various embodiments. Accordingly, embodiments are not limited to CNNs in general nor image classification functions in particular.

Tensor storage 615 is configured to store tensors that represent images as described above. Tensor storage 615 may comprise one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium. For the purposes of this example, suppose tensor storage 615 comprises SDRAM holding tensors stored according to one of the in-memory formats described herein above (e.g., NHWC).

CPU 610 may comprise any type of compute device capable of reading tensors from tensor storage 615 and delivering such tensors as input tensors to data arbiter 620 of neural processing unit 605. CPU 610 is also capable of receiving output tensors and/or scalars (e.g., image classification scores) from data arbiter 620. The description of the operation of neural processing unit 605 herein below assumes that CPU 610 delivers an input tensor in the form of vectors having a predetermined format such as, for example, the NHWC format. Embodiments are not, however, so limited. In other embodiments, tensor storage 615 may store tensors in a different storage format and likewise may also store metadata or other information that corresponds to the data format of the aforementioned tensors. In embodiments, such metadata or other information is likewise delivered to data arbiter 620 which may thereby determine the data format of the corresponding delivered tensor(s).

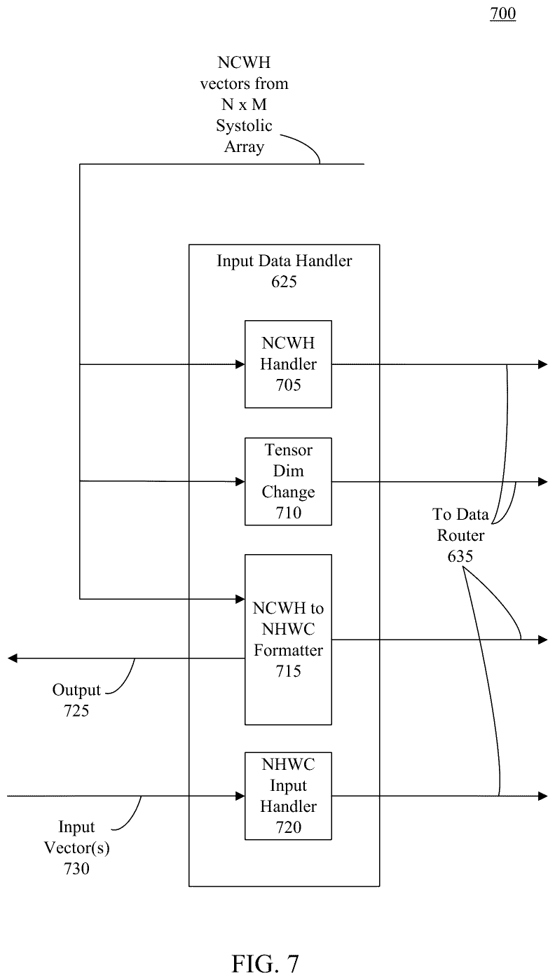

In an embodiment, data arbiter 620 is configured to send the received tensor data and a command to input data handler 625 wherein the command corresponds to the data format of the tensor data. In another embodiment, however, data arbiter 620 may instead send the received tensor data and metadata or other information to input data handler 625. In embodiments, the tensor data comprises one or more vectors that correspond to the in-memory representation of the underlying tensor data (e.g., NHWC in-memory storage representation 410). The operation and example structure of input data handler 625 will now be described with reference to FIG. 7.

FIG. 7 depicts a detailed block diagram view 700 of an input data handler 625, according to an embodiment. Input data handler 625 includes a NCWH handler 705, a tensor dim change 710, an NCWH to NHWC formatter 715 and an NHWC input handler 720. Other structural and operational embodiments will be apparent to person skilled in the relevant art(s) based on the following discussion regarding input data handler 625 as depicted in FIG. 7.

In an embodiment, input data handler 625 may be configured to accept and process vectors in numerous ways. For example, and as described briefly above, input data handler 625 may receive input vector(s) 730, along with a command indicating the format of input vector(s) 730, from data arbiter 620 and in response to that command, route input vector(s) 730 to NHWC input handler 720 for processing. In embodiments, NHWC input handler 720 is configured to determine where the elements of input vector(s) 730 should be routed and to pass input vector(s) 730 to data router 635 along with instructions on where to route each element of input vector(s) 730 (e.g., memory addresses). In such embodiments, and as will be discussed in greater detail herein below, data router 635 may comprise a passive operational block that is controlled directly by input data handler 625. In other embodiments, however, may include logic that permits data router 635 to determine for itself where to route input vector(s) 730 based on received metadata corresponding to the data format of input vector(s) 730. Such metadata may be provided to data arbiter 620 along with input vector(s) 730, or may be generated by input data handler 625 when performing in-place format changes as described herein below. Further description of the operation of neural processing unit 605 will now be presented, and the operation of NCWH handler 705, tensor dim change 710 and NCWH to NHWC formatter 715 will be described in detail thereafter below.

Embodiments take advantage of the performance benefits of a systolic array. With further reference to FIG. 6, and as described above, data router 635 receives input vector(s) 730 along with instructions or indications of where to route elements of such vectors based on the format of such vectors, and distributes the elements of input vector(s) 730 to N×M systolic array 640. A systolic array is a collection of interconnected data processing units/elements that are called cells, nodes, or clusters (the term “cluster” is used hereinafter). In embodiments, N×M systolic array 640 may be configured as a hard-wired hardware solution dedicated to a specific operation (e.g., convolution, correlation, matrix processing or sorting). In other embodiments, however, N×M systolic array 640 may be software configurable allowing the array to perform more than one type of operation. A major benefit of a systolic array for machine learning applications is that all operand data and intermediate results remain inside the array without the need to move data in and out of the array to another memory or cache via external busses. Thus, systolic arrays enable highly parallel computing while avoiding moving data in and out of relatively slow memory across slow busses. Furthermore, systolic arrays such as N×M systolic array 640 are scalable because the array size may be sized to suit the problem at hand. In embodiments, N×M systolic array 640 comprises a matrix of hundreds of clusters.

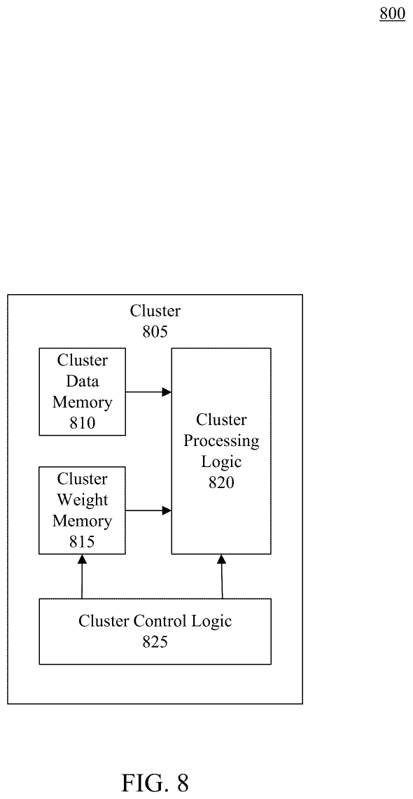

The clusters of N×M systolic array 640 may be implemented in various ways. For example, FIG. 8 depicts a detailed block diagram view 800 of a systolic array cluster 805, according to an embodiment. Cluster 805 includes a cluster data memory 810, a cluster weight memory 815, cluster processing logic 820 and a cluster controller logic 825. Other structural and operational embodiments will be apparent to persons skilled in the relevant art(s) based on the following discussion regarding cluster 805 as depicted in FIG. 8.

Each cluster 805 of N×M systolic array 640 is configured to receive tensor data a routed to it from data router 635 according to the algorithm to be executed (e.g., 2-dimensional convolution block 330 as depicted in FIG. 3), and such tensor data is stored in cluster data memory 810. Cluster weight memory 815 of cluster 805 is configured to store the weights associated with the neurons of each layer. When neural processing unit 605 is being used, the weights stored in cluster weight memory 815 will be updated and change as inference progresses. Once inference is complete, the weights stored in cluster weight memory 815 for each cluster 805 of N×M systolic array 640 can be run over during the next input handling cycle. Alternatively, such weights may subsequently be imported back into neural processing unit 605. Cluster controller logic 825 operates to update the weights stored in cluster weight memory 815 and/or to control cluster processing logic 820 depending on the particular model or application being executed within N×M systolic array 640.

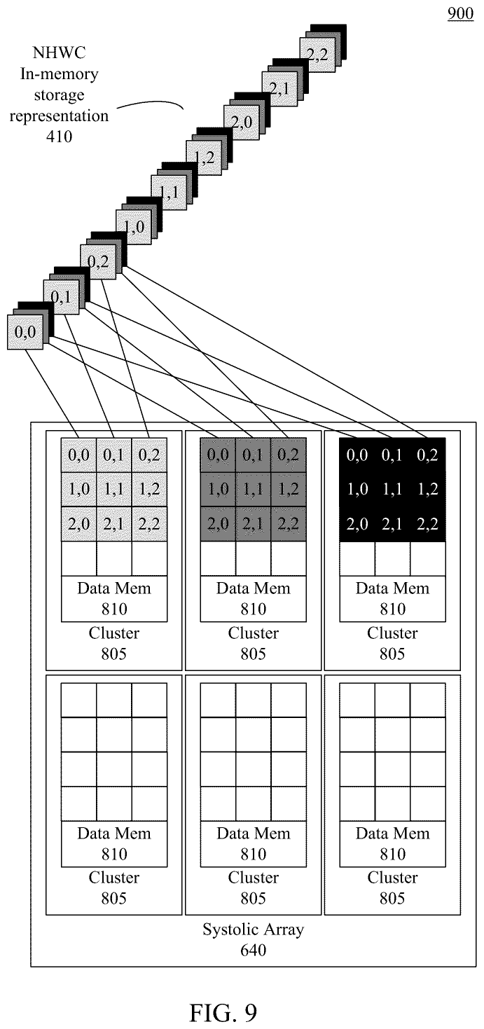

Tensors routed by data router 635 to N×M systolic array 640 are stored in clusters such that each channel of the tensor is stored in a single cluster if possible. However, data router 635 may operate to route tensors to multiple clusters as necessary in the event the tensors are too large to fit in one cluster (e.g., due to the limited amount of cluster data memory 810 built into each cluster 805). In any event, however, cluster data memory 810 of each cluster 805 will process a single channel at a convolution cycle, meaning the maximum number of channels to convolve depends on the number of clusters. To illustrate this concept, and further describe the operation of data router 635, discussion will turn now to FIG. 9.

FIG. 9 depicts a diagram illustrating an example distribution of an NHWC formatted vector 410 into clusters 805 of N×M systolic array 640 as depicted in FIG. 6, according to an embodiment. N×M systolic array 640 is depicted in FIG. 9 as being a 2×3 systolic array. Clusters 805 of FIG. 9 are shown with cluster data memory 810 with the remaining components of cluster 805 omitted for clarity. Cluster data memory 810 as shown in FIG. 9 is depicted as having 3×4=12 storage locations suitable for storage of data elements from tensor data. It should be understood, however, that any practical implementation of neural processing unit 605 will have an N×M systolic array 640 having hundreds of clusters 805, and cluster data memory 810 of each cluster 805 would have memory dimensions on the order of 8×512=4096 or more storage locations. The memory dimensions may, however, be selected according to project needs. Operation of data router 635 in conjunction with cluster data memories 810 of N×M systolic array 640 as depicted in FIG. 9 will now be described with reference to FIGS. 4a and 4b.

Suppose tensor package 405 as shown in FIG. 4a is to be used as an input tensor to neural processing unit 605. As described above, tensor package 405 is stored in tensor storage 615 as, for example, in the format depicted by NHWC in-memory storage representation 410. The tensor data depicted in NHWC in-memory storage representation 410 is, as described above, input to neural processing unit 605 and delivered to input data handler 625 which subsequently provides the tensor data to data router 635 along with some indication or instructions that reflect the fact that the tensor data has an NHWC format. Data router 635 subsequently will route the tensor data on an element-by-element basis into appropriate clusters such that any given cluster 805 stores tensor data from only a single channel. An example of this outcome is depicted in FIG. 9 whereby the tensor elements of NHWC in-memory storage representation 410 are routed to cluster data memory 810 in clusters 805 such that each cluster contains data from only a single channel. In embodiments, data router 635 and/or input data handler 625 may be configured to handle any data format such that the 1 to 1 relationship between channels and clusters is maintained where possible.

It should be understood that the above described routing of tensors resulting in each channel of a tensor being stored in a single cluster is merely exemplary, and embodiments of N×M systolic array 640 of neural processing unit 605 may operate with partitioned cluster data memory 810 such that more than a single channel may be stored per cluster. In embodiments, data router 635 and/or cluster data memory 810 may also be configured to implement channel transposition where subsequent computations (e.g., convolution) would be more efficient.

With reference to FIG. 6, further operational aspects of neural processing unit 605 will now be discussed. As described above, clusters 805 of N×M systolic array 640 are configured to receive tensor data and/or weight data and perform operations such as convolution operations thereon. As also described above, neural processing unit 605 may be configured to execute a series of such operations in sequence. For example, 2-dimensional convolution operations 330 and 335 as depicted in FIG. 3 are performed one after the other in sequence but employ different filters. In particular, convolution 330 utilizes a <64×1×1×64> filter whereas convolution 335 utilizes a <64×3×3×64> filter. As also shown in FIG. 3, a tensor of dimensions <1×56×56×64> is output from convolution 330 and used as input to convolution 335. To accomplish these convolution operations in sequence, it is necessary, therefore, to reconfigure the operation of N×M systolic array 640 of neural processing unit 605 to use a different filter, and it is likewise necessary to populate the cluster data memories 810 of clusters 805 with the output data from convolution 330 thereby replacing the input data used to perform convolution 330.

Reconfiguring N×M systolic array 640 to perform, for example, a new convolution operation with different filters may be performed by NPU controller 630 in conjunction with array controller 645. NPU controller 630 and array controller 645 likewise enable the reconfiguration of N×M systolic array 640 for performing different types of operations, in embodiments.

To accomplish these operations, embodiments employ output data handler 650 as depicted in FIG. 6. Output data handler 650 is configured to accept the computation results output from N×M systolic array 640 (e.g., the <1×56×56×64> tensor output from convolution 330) and direct that data back to input data handler 625 where such data may be routed back into N×M systolic array 640 in the manner described above with respect to input tensors arriving from data arbiter 620. Output data handler 650 will typically output tensors in NCWH format. In such instances, NHWC input handler 720 as shown in FIG. 7 is not an appropriate handler. Embodiments of input data handler 625 include, therefore, NCWH handler 705 which, as depicted in FIG. 7, configured to accept NCWH formatted tensor vectors from N×M systolic array 640 and route such vectors to data router 635. NCWH handler 705 is likewise configured to provide data router 635 with an indicator, information, metadata or a command that reflects the fact that the tensor vectors being provided are in NCWH format thereby enabling data router 635 to route appropriate data elements to appropriate clusters 805 of N×M systolic array 640 in the manner described above whereby any given cluster preferably includes data elements from only one channel. In another embodiment, output data handler 650 may be configured to change the format of tensors/vectors it receives as output from N×M systolic array 640. For example, output data handler 650 may receive NCWH formatted tensors/vectors from N×M systolic array 640 and reformat the data into NHWC format before routing the reformatted tensor back to input data handler 625.

After the clusters 805 of N×M systolic array 640 are appropriately populated with the tensor data previously output by, for example convolution 330, the next operation (e.g., convolution 335) may be executed by N×M systolic array 640. In this general manner, an arbitrary number of computation steps may be executed on tensor data and intermediate results from prior computation steps, each in sequence without a need for data to move in and out of neural processing unit 605 until all computation is complete.

With continued reference to input data handler 625 as depicted in FIG. 7, embodiments of input data handler 625 of neural processing unit 605 are further configured to execute a tensor dimension change using tensor dim change 710. For example, suppose that a computation executed on N×M systolic array 640 output a tensor vector that is <1×6> and the next computation step requires, or would preferably employ, a vector with different dimensions (e.g., <2×3>). In such instances, the <1×6> vector sent by output data handler 650 back to input data handler 625 may be provided to tensor dim change 710 along with a command issued by, for example, NPU controller 630 that causes tensor dim change 710 of input data handler 625 to transform the <1×6> vector into a <2×3> vector and then provide the modified vector to data router 635 for routing to appropriate clusters 805 of N× M systolic array 640 for the next computation step.

Input data handler 625 as depicted in FIG. 7 also includes a NCWH to NHWC formatter 715 that may accept tensors or vectors in NCWH format from output data handler 650, and then reorder to the elements of the tensor or vector thereby reformatting the output into NHWC format. In an embodiment, NCWH to NHWC formatter 715 is configured to output the NHWC formatted tensor or vector to data arbiter 620 that is in turn configured to export the result out of neural processing unit 605 (e.g., back to CPU 610 for storage in tensor storage 615).

The ability of input data handler 625 and/or output data handler 650 to change the format of tensors/vectors received as output from N×M systolic array 640 provides a significant technical benefit inasmuch as such format changes occur in-place (i.e., inside neural processing unit 605) without requiring the tensors/vectors to be moved on and off neural processing unit 605 which would limit performance and scalability due to the performance bottlenecks inherent to data bus and/or memory bandwidth limitations.

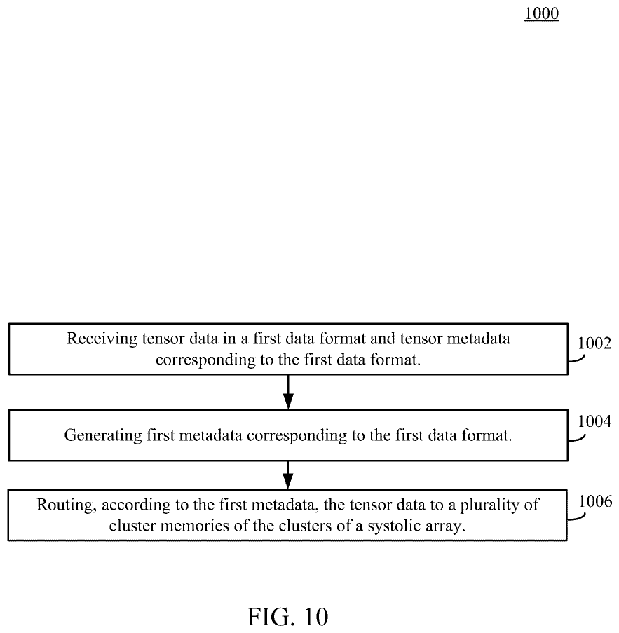

Further operational aspects of neural processing unit 605 of FIG. 6 are described as follows in conjunction with FIG. 10. FIG. 10 depicts a flowchart 1000 of an example method for operating a neural processing unit 605, according to an embodiment. Flowchart 1000 is described with continued reference to FIGS. 4, 6, 7, 8 and 9. However, other structural and operational embodiments will be apparent to persons skilled in the relevant art(s) based on the following discussion regarding flowchart 1000 of FIG. 10 and neural processing unit 605 of FIG. 6.

Flowchart 1000 begins at step 1002. At step 1002, tensor data in a first data format and tensor metadata corresponding to the first data format are received. For example, and with reference to neural processing unit 605 as depicted in FIG. 6 and as described above, tensor data such as tensor package 405 in NHWC format is received at data arbiter 620 along with tensor metadata describing or denoting the fact that tensor package 405 is in NHWC format. Flowchart 1000 of FIG. 10 continues at step 1004.

In step 1004, first metadata corresponding to the first data format is generated. For example, and with reference to neural processing unit 605 as depicted in FIG. 6 and as described above, data arbiter 620 generates metadata or other information indicative of the fact that tensor package 405 is in NHWC format and thereafter delivers tensor package 405 and said metadata to input data handler 625 that in turn sends said tensor package 405 and metadata to data router 635. Flowchart 1000 of FIG. 10 concludes at step 1006.

In step 1006, the tensor data is routed, according to the first metadata, to a plurality of cluster memories of clusters of a systolic array. For example, and with reference to neural processing unit 605 as depicted in FIG. 6, cluster 805 as depicted in FIG. 8 and diagram 900 of FIG. 9, and as described above, data router 635 is configured to route the data elements of tensor package 405 into appropriate locations in cluster data memories 810 within clusters 805 of N×M systolic array 640. Data router 635 determines which clusters should receive particular data elements of tensor package 405 according to the first metadata that reflects the format of tensor package 405.

In the foregoing discussion of steps 1002-1006 of flowchart 1000, it should be understood that at times, such steps may be performed in a different order or even contemporaneously with other steps. Other operational embodiments will be apparent to persons skilled in the relevant art(s). Note also that the foregoing general description of the operation of neural processing unit 605 is provided for illustration only, and embodiments of neural processing unit 605 may comprise different hardware and/or software, and may operate in manners different than described above. Indeed, steps of flowchart 1000 may be performed in various ways.

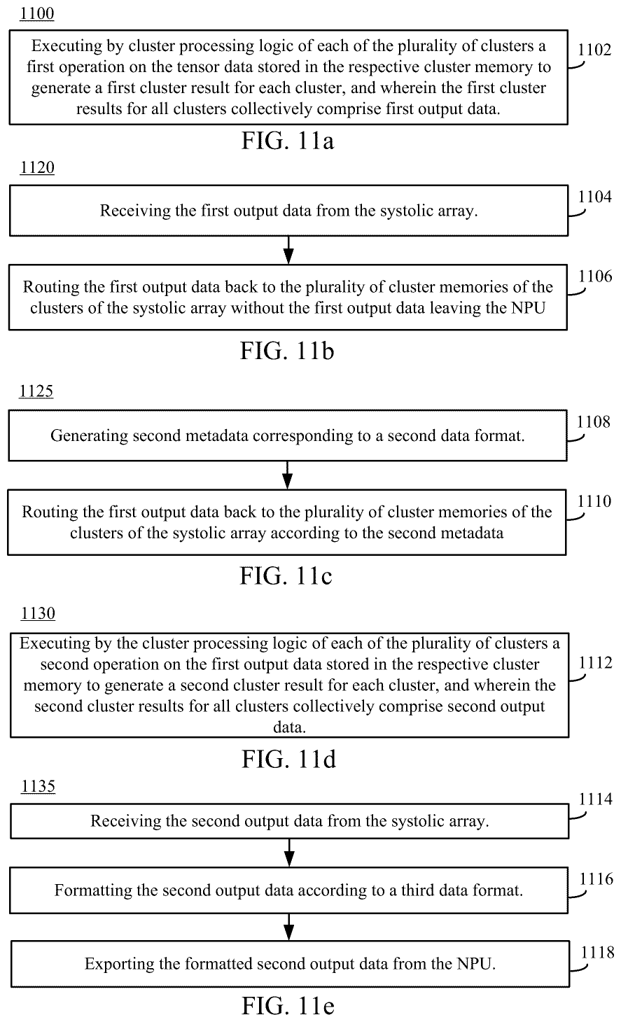

For example, FIG. 11a depicts a flowchart 1100 of a refinement to the method of flowchart 1000 of FIG. 10, according to an embodiment. Accordingly, flowchart 1100 is described with continued reference to FIGS. 4, 6, 7, 8 and 9. However, other structural and operational embodiments will be apparent to persons skilled in the relevant art(s) based on the following discussion regarding flowchart 1100 of FIG. 11a and neural processing unit 605 of FIG. 6.

Flowchart 1100 begins at step 1102. At step 1102, cluster processing logic of each of the plurality of clusters execute a first operation on the tensor data stored in the respective cluster memory to generate a first cluster result for each cluster, and wherein the first cluster results for all clusters collectively comprise first output data. For example, and with continued reference to FIGS. 4, 6, 7, 8 and 9, NPU controller 630 and array controller 645 together cause cluster processing logic 820 of each cluster 805 of N×M systolic array 640 to execute an operation such as, for example, a convolution operation on the tensor data stored in cluster data memory 810 of each cluster 805, and the convolution results for all clusters 805 comprise the first output data. In the foregoing discussion of step 1102 of flowchart 1100, other operational embodiments will be apparent to persons skilled in the relevant art(s).

FIG. 11b depicts a flowchart 1120 of a refinement to the method of flowcharts 1000 and 1100 of FIGS. 10 and 11a, respectively, according to an embodiment. Accordingly, flowchart 1120 is described with continued reference to FIGS. 4, 6, 7, 8 and 9. However, other structural and operational embodiments will be apparent to persons skilled in the relevant art(s) based on the following discussion regarding flowchart 1120 of FIG. 11b and neural processing unit 605 of FIG. 6.

Flowchart 1120 begins at step 1104. At step 1104, the first output data from the systolic array is received. For example, and with continued reference to FIGS. 4, 6, 7, 8 and 9, output data handler 650 of neural processing unit 605 as depicted in FIG. 6 receives the first output data from N×M systolic array 640. Flowchart 1120 of FIG. 11b concludes at step 1106.

In step 1106, the first output data is routed back to the plurality of cluster memories of the clusters of the systolic array without the first output data leaving the NPU. For example, and with continued reference to FIGS. 4, 6, 7, 8 and 9, output data handler 650 of neural processing unit 605 provides the first output data to input data handler 625 along with an indication of the format of first output data. As discussed in detail above, input data handler 625 then imports the output data back into the cluster data memories 810 of clusters 805 of N×M systolic array 640 in the same manner described above in conjunction with step 1006 of flowchart 1000 of FIG. 10.

In the foregoing discussion of steps 1104-1106 of flowchart 1120, it should be understood that at times, such steps may be performed differently and other operational embodiments will be apparent to persons skilled in the relevant art(s).

FIG. 11c depicts a flowchart 1125 of a refinement to the method of flowcharts 1000, 1100 and 1120 of FIGS. 10, 11a and 11b, respectively, according to an embodiment. Accordingly, flowchart 1125 is described with continued reference to FIGS. 4, 6, 7, 8 and 9. However, other structural and operational embodiments will be apparent to persons skilled in the relevant art(s) based on the following discussion regarding flowchart 1125 of FIG. 11c and neural processing unit 605 of FIG. 6.

Flowchart 1125 begins at step 1108. At step 1108, second metadata corresponding to a second data format is generated. For example, and with reference to neural processing unit 605 as depicted in FIG. 6 and as described above, input data handler 625 generates metadata or other information that reflects the format of the output tensors received from output data handler 650. Flowchart 1125 of FIG. 11c concludes at step 1110.

In step 1110, the first output data is routed back to the plurality of cluster memories of the clusters of the systolic array according to the second metadata. For example, and with reference to neural processing unit 605 as depicted in FIG. 6, cluster 805 as depicted in FIG. 8 and diagram 900 of FIG. 9, and as described above, after input data handler 625 generates metadata corresponding to the format of the output tensors received from output data handler 650, input data handler 625 passes such output tensors/vectors to data router 635 that is configured to route the data elements of the output tensors into appropriate locations in cluster data memories 810 within clusters 805 of N×M systolic array 640. For instance, the output tensors received from output data handler 650 may be formatted according to a second data format (e.g., NCWH). By routing the data elements of the output tensors, according to the metadata, back into cluster data memories 810 in the same second data format, processing cycles and memory are saved by avoiding conversion of the data elements back to the first data format (e.g., NHWC) and then back again to the second data format. Data router 635 determines which clusters should receive particular data elements of tensor package 405 according to the second metadata.

FIG. 11d depicts a flowchart 1130 of a refinement to the method of flowcharts 1000, 1100, 1120 and/or 1125 of FIGS. 10, 11a, 11b and 11c, respectively, according to an embodiment. Accordingly, flowchart 1130 is described with continued reference to FIGS. 4, 6, 7, 8 and 9. However, other structural and operational embodiments will be apparent to persons skilled in the relevant art(s) based on the following discussion regarding flowchart 1130 of FIG. 11d and neural processing unit 605 of FIG. 6. Flowchart 1130 begins at step 1112.

At step 1112, cluster processing logic of each of the plurality of clusters executes a second operation on the first output data stored in the respective cluster memory to generate a second cluster result for each cluster, and wherein the second cluster results for all clusters collectively comprise second output data. For example, and with continued reference to FIGS. 4, 6, 7, 8 and 9, NPU controller 630 and array controller 645 together cause cluster processing logic 820 of each cluster 805 of N×M systolic array 640 to execute an operation such as, for example, a convolution operation (e.g., 2-dimensional convolution 335 as depicted in FIG. 3) on the tensor data stored in cluster data memory 810 of each cluster 805, and the convolution results for all clusters 805 comprise the second output data. Each iteration of generating a second cluster result for each cluster to generate second output data furthers the generation of the ultimate output of NPU 605. In the foregoing discussion of step 1112 of flowchart 1135, it should be understood that at times, such steps may be performed differently and other operational embodiments will be apparent to persons skilled in the relevant art(s).

FIG. 11e depicts a flowchart 1135 of a refinement to the method of flowcharts 1000, 1100, 1120, 1125 and/or 1130 of FIGS. 10, 11a, 11b, 11c and 11d, respectively, according to an embodiment. Accordingly, flowchart 1135 is described with continued reference to FIGS. 4, 6, 7, 8 and 9. However, other structural and operational embodiments will be apparent to persons skilled in the relevant art(s) based on the following discussion regarding flowchart 1135 of FIG. 11e and neural processing unit 605 of FIG. 6. Flowchart 1135 begins at step 1114.

At step 1114, second output data is received from the systolic array. For example, and with reference to neural processing unit 605 as depicted in FIG. 6 and as described above, output data handler 650 of neural processing unit 605 as depicted in FIG. 6 receives the second output data from N×M systolic array 640. Furthermore, input data handler 625 likewise receives the second output data from output data handler 650. Flowchart 1135 of FIG. 11e continues at step 1116.

In step 1116, the second output data is formatted according to a third data format. For example, and with reference to neural processing unit 605 as depicted in FIG. 6 and as described above, output data handler 650 may be configured to format the second output data received from N×M systolic array 640. In an alternative embodiment, input data handler 625 may format the second output data received from output data handler 650 using, for example, NCWH to NHWC formatter 715 as depicted in FIG. 7. Flowchart 1135 of FIG. 11e concludes at step 1118.

In step 1118, the formatted second output data is exported from the NPU. For example, and with reference to neural processing unit 605 as depicted in FIG. 6, cluster 805 as depicted in FIG. 8 and diagram 900 of FIG. 9, and as described above, NCWH to NHWC formatter 715 as depicted in FIG. 7 is configured output the formatted tensor data back to data arbiter 620 which in turn export the final data back to, for example, CPU 610 of FIG. 6. The final output tensor data in the third data format, such as the data being formatted back into NHWC format, enables further processing of the output tensor data according to conventional processing techniques, thereby enabling conventional processing mechanisms to process the output tensor data.

In the foregoing discussion of steps 1114-1116 of flowchart 1135, it should be understood that at times, such steps may be performed in a different order or even contemporaneously with other steps. Other operational embodiments will be apparent to persons skilled in the relevant art(s). Note also that the foregoing general description of the operation of neural processing unit 605 is provided for illustration only, and embodiments of neural processing unit 605 may comprise different hardware and/or software, and may operate in manners different than described above.

### III. Example Computer System Implementation

Each of data arbiter 620, input data handler 625, NPU controller 630, data router 635, N×M systolic array 640, array controller 645, output data handler 650, NCWH handler 705, tensor dim change 710, NCWH to NHWC formatter 715, NHWC input handler 720, cluster data memory 810, cluster weight memory 815, cluster controller logic 825, and/or cluster processing logic 820, and flowcharts 1000, 1100, 1120, 1125, 1130 and/or 1135 may be implemented in hardware, or hardware combined with software and/or firmware. For example, data arbiter 620, input data handler 625, NPU controller 630, data router 635, N×M systolic array 640, array controller 645, output data handler 650, NCWH handler 705, tensor dim change 710, NCWH to NHWC formatter 715, NHWC input handler 720, cluster data memory 810, cluster weight memory 815, cluster controller logic 825, and/or cluster processing logic 820, and flowcharts 1000, 1100, 1120, 1125, 1130 and/or 1135 may be implemented as computer program code/instructions configured to be executed in one or more processors and stored in a computer readable storage medium. Alternatively, data arbiter 620, input data handler 625, NPU controller 630, data router 635, N×M systolic array 640, array controller 645, output data handler 650, NCWH handler 705, tensor dim change 710, NCWH to NHWC formatter 715, NHWC input handler 720, cluster data memory 810, cluster weight memory 815, cluster controller logic 825, and/or cluster processing logic 820, and flowcharts 1000, 1100, 1120, 1125, 1130 and/or 1135 may be implemented as hardware logic/electrical circuitry.

For instance, in an embodiment, one or more, in any combination, of data arbiter 620, input data handler 625, NPU controller 630, data router 635, N×M systolic array 640, array controller 645, output data handler 650, NCWH handler 705, tensor dim change 710, NCWH to NHWC formatter 715, NHWC input handler 720, cluster data memory 810, cluster weight memory 815, cluster controller logic 825, and/or cluster processing logic 820, and flowcharts 1000, 1100, 1120, 1125, 1130 and/or 1135 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

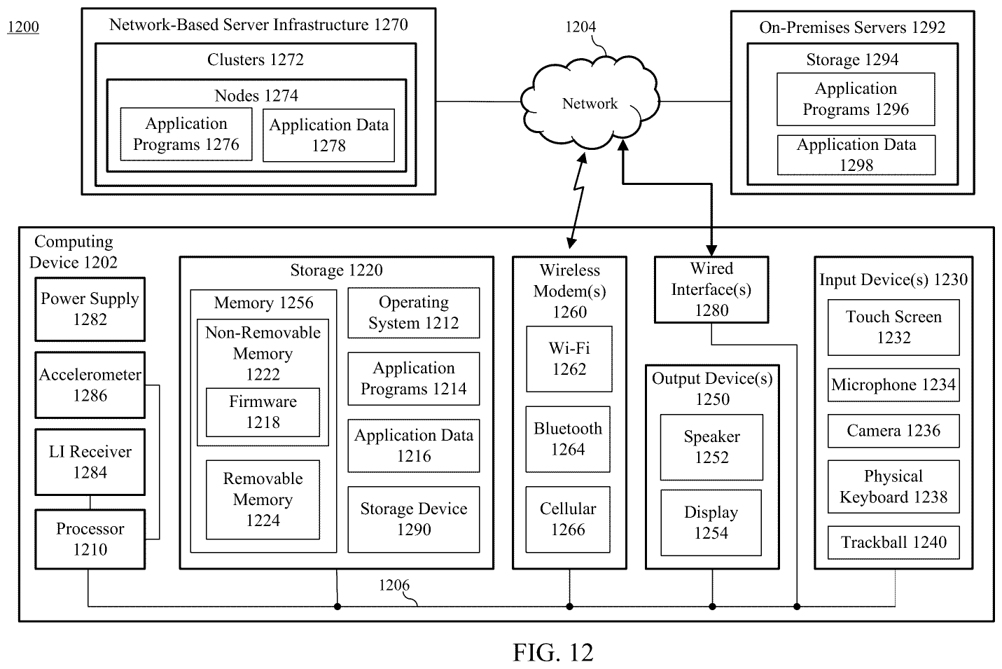

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 12. FIG. 12 shows a block diagram of an exemplary computing environment 1200 that includes a computing device 1202.

Computing device 1202 is an example of a computing device in which embodiments may be implemented. In some embodiments, computing device 1202 is communicatively coupled with devices (not shown in FIG. 12) external to computing environment 1200 via network 1204. Network 1204 comprises one or more networks such as local area networks (LANs), wide area networks (WANs), enterprise networks, the Internet, etc., and may include one or more wired and/or wireless portions. Network 1204 may additionally or alternatively include a cellular network for cellular communications. Computing device 1202 is described in detail as follows.

Computing device 1202 can be any of a variety of types of computing devices. For example, computing device 1202 may be a mobile computing device such as a handheld computer (e.g., a personal digital assistant (PDA)), a laptop computer, a tablet computer, a hybrid device, a notebook computer, a netbook, a mobile phone (e.g., a cell phone or smart phone, etc.), a wearable computing device (e.g., a head-mounted augmented reality and/or virtual reality device including smart glasses, etc.), or other type of mobile computing device. Computing device 1202 may alternatively be a stationary computing device such as a desktop computer, a personal computer (PC), a stationary server device, a minicomputer, a mainframe, a supercomputer, etc.

As shown in FIG. 12, computing device 1202 includes a variety of hardware and software components, including a processor 1210, a storage 1220, one or more input devices 1230, one or more output devices 1250, one or more wireless modems 1260, one or more wired interfaces 1280, a power supply 1282, a location information (LI) receiver 1284, and an accelerometer 1286. Storage 1220 includes memory 1256, which includes non-removable memory 1222 and removable memory 1224, and a storage device 1290. Storage 1220 also stores an operating system 1212, application programs 1214, and application data 1216. Wireless modem(s) 1260 include a Wi-Fi modem 1262, a Bluetooth modem 1264, and a cellular modem 1266. Output device(s) 1250 includes a speaker 1252 and a display 1254. Input device(s) 1230 includes a touch screen 1232, a microphone 1234, a camera 1236, a physical keyboard 1238, and a trackball 1240. Not all components of computing device 1202 shown in FIG. 12 are present in all embodiments, additional components not shown may be present, and any combination of the components may be present in a particular embodiment. These components of computing device 1202 are described as follows.

A single processor 1210 (e.g., central processing unit (CPU), microcontroller, a microprocessor, signal processor, ASIC (application specific integrated circuit), and/or other physical hardware processor circuit) or multiple processors 1210 may be present in computing device 1202 for performing such tasks as program execution, signal coding, data processing, input/output processing, power control, and/or other functions. Processor 1210 may be a single-core or multi-core processor, and each processor core may be single-threaded or multithreaded (to provide multiple threads of execution concurrently). Processor 1210 is configured to execute program code stored in a computer readable medium, such as program code of operating system 1212 and application programs 1214 stored in storage 1220. The program code is structured to cause processor 1210 to perform operations, including the processes/methods disclosed herein. Operating system 1212 controls the allocation and usage of the components of computing device 1202 and provides support for one or more application programs 1214 (also referred to as “applications” or “apps”). Application programs 1214 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1202 can communicate with any other component according to function, although not all connections are shown for ease of illustration. For instance, as shown in FIG. 12, bus 1206 is a multiple signal line communication medium (e.g., conductive traces in silicon, metal traces along a motherboard, wires, etc.) that may be present to communicatively couple processor 1210 to various other components of computing device 1202, although in other embodiments, an alternative bus, further buses, and/or one or more individual signal lines may be present to communicatively couple components. Bus 1206 represents one or more of any of several types of bus structures, including a memory bus or memory controller, a peripheral bus, an accelerated graphics port, and a processor or local bus using any of a variety of bus architectures.

Storage 1220 is physical storage that includes one or both of memory 1256 and storage device 1290, which store operating system 1212, application programs 1214, and application data 1216 according to any distribution. Non-removable memory 1222 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1222 may include main memory and may be separate from or fabricated in a same integrated circuit as processor 1210. As shown in FIG. 12, non-removable memory 1222 stores firmware 1218, which may be present to provide low-level control of hardware. Examples of firmware 1218 include BIOS (Basic Input/Output System, such as on personal computers) and boot firmware (e.g., on smart phones). Removable memory 1224 may be inserted into a receptacle of or otherwise coupled to computing device 1202 and can be removed by a user from computing device 1202. Removable memory 1224 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1290 may be present that are internal and/or external to a housing of computing device 1202 and may or may not be removable. Examples of storage device 1290 include a hard disk drive, a SSD, a thumb drive (e.g., a USB (Universal Serial Bus) flash drive), or other physical storage device.

One or more programs may be stored in storage 1220. Such programs include operating system 1212, one or more application programs 1214, and other program modules and program data. Examples of such application programs may include, for example, computer program logic (e.g., computer program code/instructions) for implementing, utilizing, or supporting operation of one or more of data arbiter 620, input data handler 625, NPU controller 630, data router 635, N×M systolic array 640, array controller 645, output data handler 650, NCWH handler 705, tensor dim change 710, NCWH to NHWC formatter 715, NHWC input handler 720, cluster data memory 810, cluster weight memory 815, cluster controller logic 825, and/or cluster processing logic 820, and flowcharts 1000, 1100, 1120, 1125, 1130 and/or 1135 (including any suitable step of flowcharts 1000, 1100, 1120, 1125, 1130 and/or 1135) described herein, including portions thereof, and/or further examples described herein.

Storage 1220 also stores data used and/or generated by operating system 1212 and application programs 1214 as application data 1216. Examples of application data 1216 include web pages, text, images, tables, sound files, video data, and other data, which may also be sent to and/or received from one or more network servers or other devices via one or more wired or wireless networks. Storage 1220 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1202 through one or more input devices 1230 and may receive information from computing device 1202 through one or more output devices 1250. Input device(s) 1230 may include one or more of touch screen 1232, microphone 1234, camera 1236, physical keyboard 1238 and/or trackball 1240 and output device(s) 1250 may include one or more of speaker 1252 and display 1254. Each of input device(s) 1230 and output device(s) 1250 may be integral to computing device 1202 (e.g., built into a housing of computing device 1202) or external to computing device 1202 (e.g., communicatively coupled wired or wirelessly to computing device 1202 via wired interface(s) 1280 and/or wireless modem(s) 1260). Further input devices 1230 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1254 may display information, as well as operating as touch screen 1232 by receiving user commands and/or other information (e.g., by touch, finger gestures, virtual keyboard, etc.) as a user interface. Any number of each type of input device(s) 1230 and output device(s) 1250 may be present, including multiple microphones 1234, multiple cameras 1236, multiple speakers 1252, and/or multiple displays 1254.

One or more wireless modems 1260 can be coupled to antenna(s) (not shown) of computing device 1202 and can support two-way communications between processor 1210 and devices external to computing device 1202 through network 1204, as would be understood to persons skilled in the relevant art(s). Wireless modem 1260 is shown generically and can include a cellular modem 1266 for communicating with one or more cellular networks, such as a GSM network for data and voice communications within a single cellular network, between cellular networks, or between the mobile device and a public switched telephone network (PSTN). Wireless modem 1260 may also or alternatively include other radio-based modem types, such as a Bluetooth modem 1264 (also referred to as a “Bluetooth device”) and/or Wi-Fi modem 1262 (also referred to as an “wireless adaptor”). Wi-Fi modem 1262 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1264 is configured to communicate with another Bluetooth-capable device according to the Bluetooth short-range wireless technology standard(s) such as IEEE 802.15.1 and/or managed by the Bluetooth Special Interest Group (SIG).

Computing device 1202 can further include power supply 1282, LI receiver 1284, accelerometer 1286, and/or one or more wired interfaces 1280. Example wired interfaces 1280 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or a Lightning® port, the purposes and functions of each of which are well known to persons skilled in the relevant art(s). Wired interface(s) 1280 of computing device 1202 provide for wired connections between computing device 1202 and network 1204, or between computing device 1202 and one or more devices/peripherals when such devices/peripherals are external to computing device 1202 (e.g., a pointing device, display 1254, speaker 1252, camera 1236, physical keyboard 1238, etc.). Power supply 1282 is configured to supply power to each of the components of computing device 1202 and may receive power from a battery internal to computing device 1202, and/or from a power cord plugged into a power port of computing device 1202 (e.g., a USB port, an A/C power port). LI receiver 1284 may be used for location determination of computing device 1202 and may include a satellite navigation receiver such as a Global Positioning System (GPS) receiver or may include other type of location determiner configured to determine location of computing device 1202 based on received information (e.g., using cell tower triangulation, etc.). Accelerometer 1286 may be present to determine an orientation of computing device 1202.

Note that the illustrated components of computing device 1202 are not required or all-inclusive, and fewer or greater numbers of components may be present as would be recognized by one skilled in the art. For example, computing device 1202 may also include one or more of a gyroscope, barometer, proximity sensor, ambient light sensor, digital compass, etc. Processor 1210 and memory 1256 may be co-located in a same semiconductor device package, such as being included together in an integrated circuit chip, FPGA, or system-on-chip (SOC), optionally along with further components of computing device 1202.

In embodiments, computing device 1202 is configured to implement any of the above-described features of flowcharts herein. Computer program logic for performing any of the operations, steps, and/or functions described herein may be stored in storage 1220 and executed by processor 1210.

In some embodiments, server infrastructure 1270 may be present in computing environment 1200 and may be communicatively coupled with computing device 1202 via network 1204. Server infrastructure 1270, when present, may be a network-accessible server set (e.g., a cloud-based environment or platform). As shown in FIG. 12, server infrastructure 1270 includes clusters 1272. Each of clusters 1272 may comprise a group of one or more compute nodes and/or a group of one or more storage nodes. For example, as shown in FIG. 12, cluster 1272 includes nodes 1274. Each of nodes 1274 are accessible via network 1204 (e.g., in a “cloud-based” embodiment) to build, deploy, and manage applications and services. Any of nodes 1274 may be a storage node that comprises a plurality of physical storage disks, SSDs, and/or other physical storage devices that are accessible via network 1204 and are configured to store data associated with the applications and services managed by nodes 1274. For example, as shown in FIG. 12, nodes 1274 may store application data 1278.

Each of nodes 1274 may, as a compute node, comprise one or more server computers, server systems, and/or computing devices. For instance, a node 1274 may include one or more of the components of computing device 1202 disclosed herein. Each of nodes 1274 may be configured to execute one or more software applications (or “applications”) and/or services and/or manage hardware resources (e.g., processors, memory, etc.), which may be utilized by users (e.g., customers) of the network-accessible server set. For example, as shown in FIG. 12, nodes 1274 may operate application programs 1276. In an implementation, a node of nodes 1274 may operate or comprise one or more virtual machines, with each virtual machine emulating a system architecture (e.g., an operating system), in an isolated manner, upon which applications such as application programs 1276 may be executed.

In an embodiment, one or more of clusters 1272 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1272 may be a datacenter in a distributed collection of datacenters. In embodiments, exemplary computing environment 1200 comprises part of a cloud-based platform.

In an embodiment, computing device 1202 may access application programs 1276 for execution in any manner, such as by a client application and/or a web browser at computing device 1202.

For purposes of network (e.g., cloud) backup and data security, computing device 1202 may additionally and/or alternatively synchronize copies of application programs 1214 and/or application data 1216 to be stored at network-based server infrastructure 1270 as application programs 1276 and/or application data 1278. For instance, operating system 1212 and/or application programs 1214 may include a file hosting service client configured to synchronize applications and/or data stored in storage 1220 at network-based server infrastructure 1270.

In some embodiments, on-premises servers 1292 may be present in computing environment 1200 and may be communicatively coupled with computing device 1202 via network 1204. On-premises servers 1292, when present, are hosted within an organization's infrastructure and, in many cases, physically onsite of a facility of that organization. On-premises servers 1292 are controlled, administered, and maintained by IT (Information Technology) personnel of the organization or an IT partner to the organization. Application data 1298 may be shared by on-premises servers 1292 between computing devices of the organization, including computing device 1202 (when part of an organization) through a local network of the organization, and/or through further networks accessible to the organization (including the Internet). Furthermore, on-premises servers 1292 may serve applications such as application programs 1296 to the computing devices of the organization, including computing device 1202. Accordingly, on-premises servers 1292 may include storage 1294 (which includes one or more physical storage devices such as storage disks and/or SSDs) for storage of application programs 1296 and application data 1298 and may include one or more processors for execution of application programs 1296. Still further, computing device 1202 may be configured to synchronize copies of application programs 1214 and/or application data 1216 for backup storage at on-premises servers 1292 as application programs 1296 and/or application data 1298.

Embodiments described herein may be implemented in one or more of computing device 1202, network-based server infrastructure 1270, and on-premises servers 1292. For example, in some embodiments, computing device 1202 may be used to implement systems, clients, or devices, or components/subcomponents thereof, disclosed elsewhere herein. In other embodiments, a combination of computing device 1202, network-based server infrastructure 1270, and/or on-premises servers 1292 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1220. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1214) may be stored in storage 1220. Such computer programs may also be received via wired interface(s) 1280 and/or wireless modem(s) 1260 over network 1204. Such computer programs, when executed or loaded by an application, enable computing device 1202 to implement features of embodiments discussed herein. Accordingly, such computer programs represent controllers of the computing device 1202.

Embodiments are also directed to computer program products comprising computer code or instructions stored on any computer-readable medium or computer-readable storage medium. Such computer program products include the physical storage of storage 1220 as well as further physical storage types.

### IV. Additional Example Embodiments

A neural processing unit (NPU) is provided herein. In an embodiment, the NPU comprises: a data arbiter configured to receive tensor data in a first data format and tensor metadata comprising a tensor data descriptor corresponding to the first data format; an input data handler; a data router; a systolic array comprising a plurality of clusters, each including a cluster memory and cluster processing logic; and wherein the data arbiter is configured to send the tensor data and a command corresponding to the tensor data descriptor to the input data handler; in response to the command, the input data handler is configured to generate first metadata corresponding to the first data format, and send the tensor data and the first metadata to the data router; and the data router is configured to, according to the first metadata, route the tensor data into the plurality of cluster memories of the clusters of the systolic array.

In another embodiment of the foregoing NPU, the cluster processing logic of each of the plurality of clusters is configured to perform a first operation on the tensor data stored in the respective cluster memory to generate a first cluster result for each cluster, and wherein the first cluster results for all clusters collectively comprise first output data.

In another embodiment of the foregoing NPU, the NPU further comprises an output data handler coupled between the systolic array and the input data handler, the output data handler configured to receive the first output data from the systolic array and to send the first output data to the input data handler.

In another embodiment of the foregoing NPU, the output data handler is configured to format the output data in a second data format.

In another embodiment of the foregoing NPU, the input data handler is further configured to generate second metadata corresponding to the second data format, and to send the first output data and the second metadata to the data router, the data router configured to route the first output data to the plurality of cluster memories of the systolic array according to the second metadata.

In another embodiment of the foregoing NPU, the cluster processing logic of each of the plurality of clusters is configured to perform a second operation on the first output data stored in the respective cluster memory to generate a second cluster result for each cluster, and wherein the second cluster results for all clusters collectively comprise second output data.

In another embodiment of the foregoing NPU, the output data handler is configured to receive the second output data from the systolic array and to send the second output data to the input data handler.

In another embodiment of the foregoing NPU, the input data handler is further configured to format the second output data according to a third data format and to send the formatted second output data to the data arbiter, the data arbiter configured to export the formatted second output data.

In another embodiment of the foregoing NPU, the first and the second operations comprise convolution operations.

In another embodiment of the foregoing NPU, tensor data comprises 3-dimensional tensor data, wherein the 3-dimensional tensor data comprises a plurality of 2-dimensional channels, wherein each of the plurality of 2-dimensional channels comprises a plurality of data elements.

In another embodiment of the foregoing NPU, the data router is configured to route the tensor data according to the first metadata by designating particular ones of the plurality of cluster memories to receive the data elements corresponding to respective ones of the plurality of 2-dimensional channels, and routing the tensor data thereto.

A method of operating a neural processing unit (NPU) is provided herein, the NPU including a systolic array comprising a plurality of clusters, each including a cluster memory and cluster processing logic. The method comprising: receiving tensor data in a first data format and tensor metadata corresponding to the first data format; generating first metadata corresponding to the first data format; routing, according to the first metadata, the tensor data to the plurality of cluster memories of the clusters of the systolic array.

In an embodiment of the foregoing method, the method further comprises executing by the cluster processing logic of each of the plurality of clusters a first operation on the tensor data stored in the respective cluster memory to generate a first cluster result for each cluster, and wherein the first cluster results for all clusters collectively comprise first output data.

In an embodiment of the foregoing method, the method further comprises receiving the first output data from the systolic array; and routing the first output data back to the plurality of cluster memories of the clusters of the systolic array without the first output data leaving the NPU.

In an embodiment of the foregoing method, the first output data is formatted in a second data format.

In an embodiment of the foregoing method, the method further comprises generating second metadata corresponding to the second data format; and routing the first output data back to the plurality of cluster memories of the clusters of the systolic array according to the second metadata.

In an embodiment of the foregoing method, the method further comprises executing by the cluster processing logic of each of the plurality of clusters a second operation on the first output data stored in the respective cluster memory to generate a second cluster result for each cluster, and wherein the second cluster results for all clusters collectively comprise second output data.

In an embodiment of the foregoing method, the method further comprises receiving the second output data from the systolic array; formatting the second output data according to a third data format; and exporting the formatted second output data from the NPU.

In an embodiment of the foregoing method, the tensor data comprises 3-dimensional tensor data, wherein the 3-dimensional tensor data comprises a plurality of 2-dimensional channels, wherein each of the plurality of 2-dimensional channels comprises a plurality of data elements.

In an embodiment of the foregoing method, the method further comprises routing the tensor data according to the first metadata by designating particular ones of the plurality of cluster memories to receive the data elements corresponding to respective ones of the plurality of 2-dimensional channels, and routing the tensor data thereto.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A neural processing unit (NPU), comprising:
a data arbiter configured to receive tensor data in a first data format and tensor metadata comprising a tensor data descriptor corresponding to the first data format;
an input data handler;
a data router;
a systolic array comprising a plurality of clusters, each including a cluster memory and cluster processing logic; and
wherein the data arbiter is configured to send the tensor data and a command corresponding to the tensor data descriptor to the input data handler;
in response to the command, the input data handler is configured to generate first metadata corresponding to the first data format, and send the tensor data and the first metadata to the data router; and
the data router is configured to, according to the first metadata, route the tensor data into the plurality of cluster memories of the clusters of the systolic array.

2. The NPU of claim 1, wherein the cluster processing logic of each of the plurality of clusters is configured to perform a first operation on the tensor data stored in the respective cluster memory to generate a first cluster result for each cluster, and wherein the first cluster results for all clusters collectively comprise first output data.

3. The NPU of claim 2, wherein the NPU further comprises an output data handler coupled between the systolic array and the input data handler, the output data handler configured to receive the first output data from the systolic array and to send the first output data to the input data handler.

4. The NPU of claim 3, wherein the output data handler is configured to format the output data in a second data format.

5. The NPU of claim 4, wherein the input data handler is further configured to generate second metadata corresponding to the second data format, and to send the first output data and the second metadata to the data router, the data router configured to route the first output data to the plurality of cluster memories of the systolic array according to the second metadata.

6. The NPU of claim 5, wherein the cluster processing logic of each of the plurality of clusters is configured to perform a second operation on the first output data stored in the respective cluster memory to generate a second cluster result for each cluster, and wherein the second cluster results for all clusters collectively comprise second output data.

7. The NPU of claim 6, wherein the output data handler is configured to receive the second output data from the systolic array and to send the second output data to the input data handler.

8. The NPU of claim 7, wherein the input data handler is further configured to format the second output data according to a third data format and to send the formatted second output data to the data arbiter, the data arbiter configured to export the formatted second output data.

9. The NPU of claim 6, wherein the first and the second operations comprise convolution operations.

10. The NPU of claim 1, wherein tensor data comprises 3-dimensional tensor data, wherein the 3-dimensional tensor data comprises a plurality of 2-dimensional channels, wherein each of the plurality of 2-dimensional channels comprises a plurality of data elements.

11. The NPU of claim 10, wherein the data router is configured to route the tensor data according to the first metadata by designating particular ones of the plurality of cluster memories to receive the data elements corresponding to respective ones of the plurality of 2-dimensional channels, and routing the tensor data thereto.

12. A method of operating a neural processing unit (NPU), the NPU including a systolic array comprising a plurality of clusters, each including a cluster memory and cluster processing logic, the method comprising:
receiving tensor data in a first data format and tensor metadata corresponding to the first data format;
generating first metadata corresponding to the first data format;
routing, according to the first metadata, the tensor data to the plurality of cluster memories of the clusters of the systolic array.

13. The method of claim 12, further comprising:
executing by the cluster processing logic of each of the plurality of clusters a first operation on the tensor data stored in the respective cluster memory to generate a first cluster result for each cluster, and wherein the first cluster results for all clusters collectively comprise first output data.

14. The method of claim 13, further comprising:
receiving the first output data from the systolic array; and
routing the first output data back to the plurality of cluster memories of the clusters of the systolic array without the first output data leaving the NPU.

15. The method of claim 14, wherein the first output data is formatted in a second data format.

16. The method of claim 15, further comprising:
generating second metadata corresponding to the second data format; and
routing the first output data back to the plurality of cluster memories of the clusters of the systolic array according to the second metadata.

17. The method of claim 16, further comprising:
executing by the cluster processing logic of each of the plurality of clusters a second operation on the first output data stored in the respective cluster memory to generate a second cluster result for each cluster, and wherein the second cluster results for all clusters collectively comprise second output data.

18. The method of claim 17, further comprising:
receiving the second output data from the systolic array;
formatting the second output data according to a third data format; and
exporting the formatted second output data from the NPU.

19. The method of claim 12, wherein tensor data comprises 3-dimensional tensor data, wherein the 3-dimensional tensor data comprises a plurality of 2-dimensional channels, wherein each of the plurality of 2-dimensional channels comprises a plurality of data elements.

20. The method of claim 12, further comprising:
routing the tensor data according to the first metadata by designating particular ones of the plurality of cluster memories to receive the data elements corresponding to respective ones of the plurality of 2-dimensional channels, and routing the tensor data thereto.
